(19) United States
(12) Patent Application Publication
(10) Pub. No.: US 2007/0024713 A1
(43) Pub. Date: Feb. 1, 2007

(54) Imaging parallel interface RAM

(76) Inventors: Richard L. Baer, Los Altos, CA (US); Vamsi K. Srikantam, Fremont, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/192,894

(22) Filed: Jul. 28, 2005

(51) Int. Cl. H04N 5/225

(52) U.S. Cl. 348/207.99

(57) ABSTRACT

Imaging Parallel Interface Random Access Memory (IPIRAM). An integrated circuit imaging device presents to external circuitry as a static, parallel-interface RAM. Internally, a two-port RAM has access resolved by contention logic to permit access by external circuitry or internal imaging. The RAM is organized as one or more image buffers and a set of memory-mapped control and status registers. The imaging array, when active, automatically fills an image buffer with image data, which may be accessed by external circuitry in random-access fashion. Control and status registers may be used to start and stop the imaging process, set and interrogate imaging parameters. The IPIRAM may also include auxiliary processing circuitry to perform functions such as image compression, scaling, edge and feature extraction, and the like.

### BACKGROUND OF THE INVENTION

1. Field of the Invention

The present invention pertains to the art of image sensors, and more particularly, to interfacing high speed image sensors to digital logic.

2. Art Background

Image sensors, such as CCD or CMOS sensors have decreased in price and increased in quality and capability, making them desirous to include in small electronic devices and systems. As an example, the Micron MT9M413 sensor from Micron Technologies can capture 1.3 megapixel images at up to 500 frames per second. Partial frames (frames with reduced resolution) can be captured at more that 10,000 frames per second.

However, such sensors are difficult to use in embedded systems. They output data and synchronization signals at high rates, and require many I/O connections. The MT9M413 ships in a 280 pin ceramic package. The data interface includes 10 data ports (10 bits each) that operate at 66 MHz. The systems that use these devices must have enough computational power to decode the synchronization signals and to properly interpret the sequential data. As a consequence, high-speed image sensors are rarely used in low-power embedded systems.

High-speed image sensors produce data at such a high rate that it cannot be processed in real time. As a consequence, most high-speed image sensors are used in recording systems. The system is generally implemented with a high-speed camera and a PC. The high-speed camera provides a control interface (typically RS-232) that is used to adjust the capture conditions (e.g. exposure time), and a high-speed data interface. Commonly used high-speed interfaces include IEEE1394, CameraLink, and Gigabit Ethernet.

Disadvantages of high-speed image sensors, particularly to the designer of small or embedded systems include:

Data may only be accessed sequentially. The first row must be read out prior to the second row, and so on.

No buffering is provided. Embedded systems, in particular, have limited internal memory and may not be able to accept a complete image frame unless external memory is provided.

High-speed synchronization signals must be decoded in order to interpret the image data. Because of the high data rate, external synchronization logic is required.

The sensor “pushes” data at a fixed rate. Data must be read out of the sensor at a fixed rate or artifacts will appear in the image. Data must be “swallowed” at the rate at which it is produced. At high speed, external memory buffers are required.

A high speed clock must be provided, and must be synchronized to other elements of the system for data transfer.

Data and control signals travel on different paths.

High pin count; many I/O lines are required to control the image sensor and receive video data.

Power consumption is typically high, so the device is not suitable for use in low-power systems.

### SUMMARY OF THE INVENTION

A single-chip image sensor provides a parallel interface common to random-access-memory (RAM) chips. The Imaging Parallel-Interface RAM (IPIRAM) contains a pixel array interfaced with a dual-port RAM. All data and control transactions are performed through the parallel RAM interface. The RAM address space is divided into an area of image buffers, and an area for memory-mapped control and status registers.

### BRIEF DESCRIPTION OF THE DRAWINGS

The present invention is described with respect to particular exemplary embodiments thereof and reference is made to the drawings in which:

FIG. 1 is a block diagram of an imaging parallel interface RAM.

### DETAILED DESCRIPTION

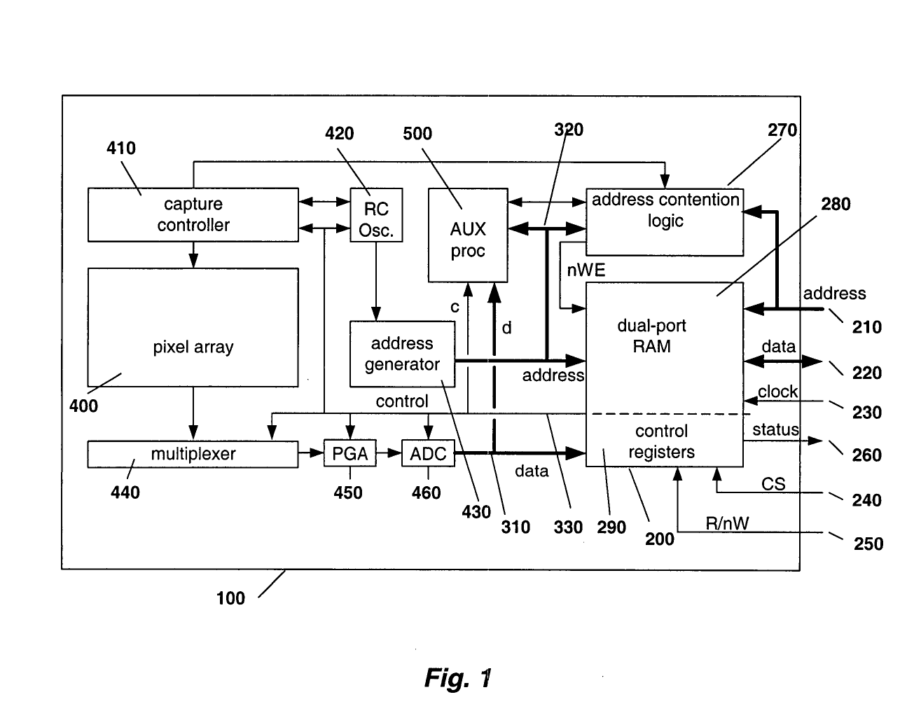

According to the present invention and as shown in FIG. 1, an imaging device is presented as a single integrated circuit (IC) parallel interface RAM, (IPIRAM). IPRAM 100 interfaces two-port RAM 200 to external logic with parallel address lines 210, parallel data lines 220, and control lines with in the example shown include clock 230, chip select (CS) 240, Read/Write line 250, and status line 260. Multiple chip select lines may be used, and other known variations of device selection may also be used. In a device organized as 64k (65536 decimal) 8-bit bytes, 16 address lines and 8 data lines would be used.

Two-port RAM designs are well known to the art. Essential in the operation of a two-port RAM is address contention logic 270, which arbitrates access to RAM contents between the external interface, address, data, and control lines 210 through 260, and internal accesses.

The address space of the RAM is preferably organized as one or more image buffers 280, and memory-mapped control and status registers 290. While the control and status registers may be mapped anywhere in the RAM address space, in the embodiment shown they are mapped into the last n locations of the RAM. In reading from memory, an address value is presented to address lines 210, and the control lines are toggled to initiate a read operation which places the selected data on data bus 220. Data values in image buffer 280 are overwritten each time a new frame is captured. Contention logic may allow external writes from external interface lines 210 through 270 through to image buffer 280 so that this memory could be accessed as general purpose memory, or the image buffer area 280 could be treated as read-only, with write requests being ignored.

In the embodiment shown, internal data 310, address 320, and control 330 busses are present.

Imaging pixel array 400 is driven by capture controller 410, which communicates with the internal control bus 330 and contention logic 270. During image acquisition, oscillator 420 is activated through control bus 330, and provides clock signals to address generator 430 and imaging controller 410. Data from the imaging array is fed through multiplexer 440 to programmable gain amplifier (PGA) 450 and to analog to digital converter (ADC) 460 where analog pixel values are converted to digital and presented on internal data bus 310 along with an address on address bus 320 to be stored in RAM 200.

Many different pixel array architectures could be used, such a CCD array, or a CMOS active-pixel (APS) architecture. CCD operation is discussed, for example, in Solid-State Imaging with Charged Coupled Devices by Theuwissen (pp. 109-128 Springer, 1995). APS architectures, such as the three transistor (3T) APS approach overcome some of the disadvantages of CCD sensors. The address event imaging architecture by Culurciello described in Proc. IEEE Intl. Symp. On Circuits and Systems 2001 (ISCAS 2001), Vol 3, pp. III-505 to III-508 could also be used. In this asynchronous architecture, a set of pixel coordinates is output whenever a pixel's voltage crosses a threshold. These coordinates could be used to increment a counter at that pixel location in buffer memory 200.

Providing an image buffer in RAM 200 allows external circuitry such as low-cost microprocessors to operate in data “pull” mode, requesting data when needed, rather than being force-fed image data by the imaging array. The entire image may be interrogated at a slow rate, in random-access fashion, or a selected group of pixels may be interrogated at a high rate. This interrogation is controlled by the external device, not the imaging array.

Control and status registers 290 provide for control of the device and the imaging process. These registers typically provide for control of the exposure period, PGA gain, and other image capture parameters such as resolution. Control bits or bytes are used to activate or deactivate image capture. Image modes such as single frame capture and continuous capture may be provided. Low frame-rate capture could also be provided, or synchronizing image capture with a particular control line or control signal so that image capture could be synchronized to an external event such as a strobe light or other illumination.

These control registers are writeable from the external interface comprising lines 210 thorough 260. Status registers are read from the external interface and provide status of the device. Status registers may be organized as separate bytes, or control and status information may be organized together, with some bits and/or fields being read-only for status information, and some fields being read/write or write only for control. As an example, setting the most significant bit of a status register byte to return one when imaging is active can simplify the programming process.

CCD and CMOS image sensors typically consume from 20 to greater than 100 milliwatts of power when active. Imaging devices which produce video data streams require precise, stable clocks for operation at standard video rates, and to decrease the visibility of lighting artifacts such as flicker. Such systems typically use a crystal clock to provide the needed precision and stability. Crystal clocks start slowly, on the order of hundreds of milliseconds, so they cannot be quickly stopped and started. In contrast, since the present invention buffers image data into RAM 200, oscillator 420 does not have to be as precise or stable. In the preferred embodiment, a quick-starting oscillator such as an R-C oscillator is used for oscillator 420. The timing components for oscillator 420 may be entirely on-chip, or may be off-chip. By providing control of oscillator 420 through control and status registers 290, the image acquisition process and oscillator 420 can be stopped and started, providing power savings. Since image data is stored in RAM 200, the image data is still available when the imaging circuitry is in a standby or low-power mode. Control and status registers 290 can optionally provide for low-resolution imaging with imaging array 400, reducing the number of pixel conversions required. High resolution image acquisition, and the associated higher power consumption, may be used only when needed.

Optionally, auxiliary processing logic 500 may be provided on-chip. Such auxiliary processing logic could include functions such as scaling of image size, scaling of image intensity, edge detection, feature extraction, image compression, motion detection, motion estimation, automatic exposure, automatic white balance, and/or dynamic range extension by combining images with different exposure durations into a single image. This auxiliary processing logic may be in the nature of fixed logic, a gate array such as an FPGA, or a microprocessor. In microprocessor implementations, memory containing the program sequences necessary for auxiliary processing may be stored in read only memory (ROM), electrically alterable memory such as EPROM, EEPROM, or Flash. Program sequences could also be provided through RAM 200.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. An imaging parallel interface RAM integrated circuit comprising:
an imaging pixel array,
a two-port buffer memory having a first parallel interface port for connecting to logic external to the integrated circuit and a second parallel interface port,
contention logic for resolving memory contention between the first and second interface ports, and
an imaging controller controlling the imaging array and imaging electronics for capturing image data from the pixel array and storing the image data in the buffer memory through the second parallel interface port.

2. The imaging parallel interface RAM of claim 1 where the timing of the imaging controller is established by an R-C clock.

3. The imaging parallel interface RAM of claim 2 where the timing components for the R-C clock are on the integrated circuit.

4. The imaging parallel interface RAM of claim 1 where the address space of the buffer memory is divided into at least one image buffer, and memory-mapped control and parameter registers.

5. The imaging parallel interface RAM of claim 4 where write operations to the at least one image buffer from the first parallel interface port are allowed.

6. The imaging parallel interface RAM of claim 4 where write operations to the at least one image buffer from the first parallel interface port are ignored.

7. The imaging parallel interface RAM of claim 4 where the control registers provide for starting and stopping image capture.

8. The imaging parallel interface RAM of claim 7 where the first parallel interface port provides random access to previously stored image data while image capture is stopped.

9. The imaging parallel interface RAM of claim 7 where the first parallel interface port provides random access to image data during image capture.

10. The imaging parallel interface RAM of claim 7 where the control registers provide for single frame image capture.

11. The imaging parallel interface RAM of claim 1 further comprising auxiliary processing logic connected to the second parallel interface port for processing stored image data from the buffer memory.

12. The imaging parallel interface RAM of claim 11 where the type of auxiliary processing to be performed is determined by data stored in the buffer memory.
